(19) United States
(12) Patent Application Publication
(10) Pub. No.: US 2024/0333030 A1
(43) Pub. Date: Oct. 3, 2024

(54) MAGNETIZED POWER TRANSFER ASSEMBLY

(71) Applicant: Matthew Hite, Walton, KY (US)

(72) Inventor: Matthew Hite, Walton, KY (US)

(21) Appl. No.: 18/128,900

(22) Filed: Mar. 30, 2023

(51) Int. Cl. H02J 50/00; H02J 50/10

(52) U.S. Cl. CPC H02J 50/005; H02J 50/10

(57) ABSTRACT

A magnetized power transfer assembly for receiving electricity from a transmitter through an open current includes an electricity transmitter transmitting electricity from a power source. An electricity receiver receives electricity from the electricity transmitter. The electricity receiver has an electrical receptacle thereon and receives a power cord, wherein the electricity receiver provides electricity from the electricity transmitter to the power cord. A conductor strip is coupled to the electricity transmitter and to the electricity receiver. The conductor strip transfers electricity from the electricity transmitter to the electricity receiver through an open current within the conductor when the electricity transmitter and the electricity receiver are electrically coupled thereto. A mount is coupled to the conductor strip and mounts the conductor strip to a surface.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to electrical receptacles and more particularly pertains to a new electrical receptacle for receiving electricity from a transmitter through an open current.

### (2) Description of Related Art Including Information Disclosed Under 37 CFR 1.97 and 1.98

The prior art relates to electrical receptacles and includes a variety of electrical receptacles being magnetically engageable with a magnetic mount. Known prior art does not include an electrical receptacle being magnetically engageable with a conductive strip and receiving electricity from a transmitter through an open current within the conductive strip.

### (h) BRIEF SUMMARY OF THE INVENTION

An embodiment of the disclosure meets the needs presented above by generally comprising an electricity transmitter being configured for transmitting electricity from a power source. An electricity receiver is configured for receiving electricity from the electricity transmitter. The electricity receiver has an electrical receptacle thereon and is configured for receiving a power cord, wherein the electricity receiver is configured to provide electricity from the electricity transmitter to the power cord. A conductor strip is couplable to the electricity transmitter and to the electricity receiver. The conductor strip is configured for transferring electricity from the electricity transmitter to the electricity receiver through an open current within the conductor when the electricity transmitter and the electricity receiver are electrically coupled thereto. A mount is coupled to the conductor strip and is configured for mounting the conductor strip to a surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a magnetized power transfer assembly according to an embodiment of the disclosure.

FIG. 2 is a side view of an embodiment of the disclosure.

FIG. 3 is a cross-sectional view of an embodiment of the disclosure taken along Line 3-3 of FIG. 2.

FIG. 4 is a cross-sectional view of an embodiment of the disclosure taken along Line 4-4 of FIG. 3.

FIG. 5 is a top isometric view of an embodiment of the disclosure.

FIG. 6 is a cross-sectional view of an embodiment of the disclosure taken along Line 6-6 of FIG. 5.

FIG. 7 is a cross-sectional view of an embodiment of the disclosure taken along Line 7-7 of FIG. 5.

FIG. 8 is an in-use view of an embodiment of the disclosure.

FIG. 9 is a cross-sectional view of an embodiment of the disclosure taken along Line 9-9 of FIG. 8.

FIG. 10 is a block diagram view of an embodiment of the disclosure.

### (j) DETAILED DESCRIPTION OF THE INVENTION

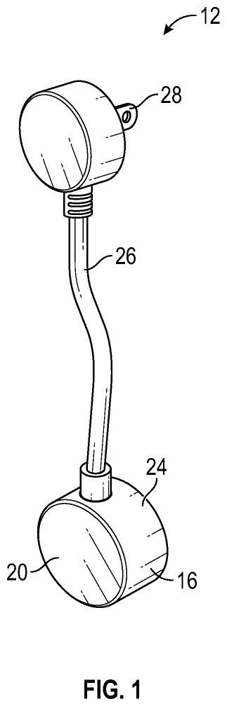

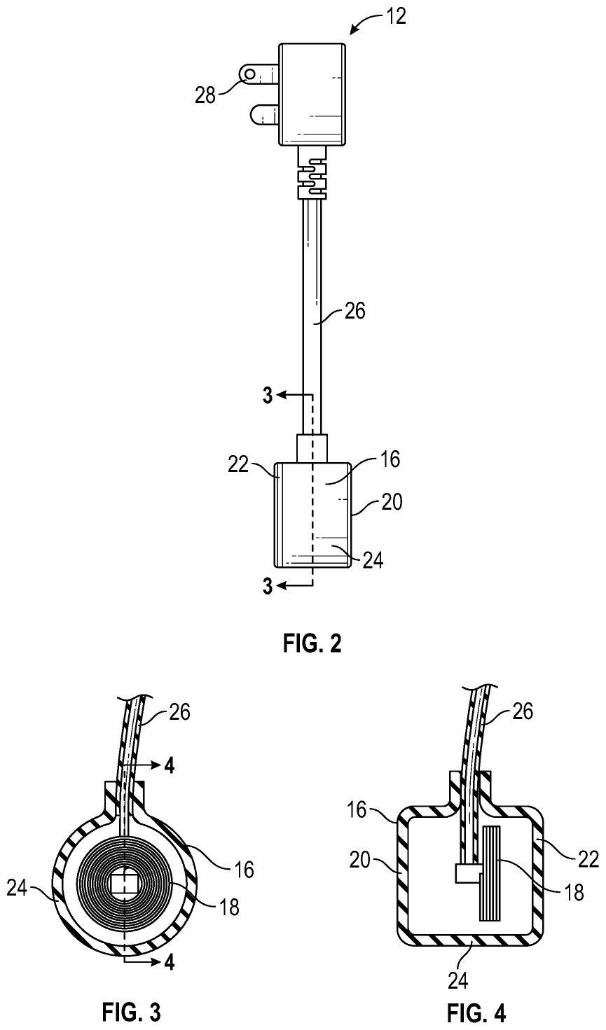

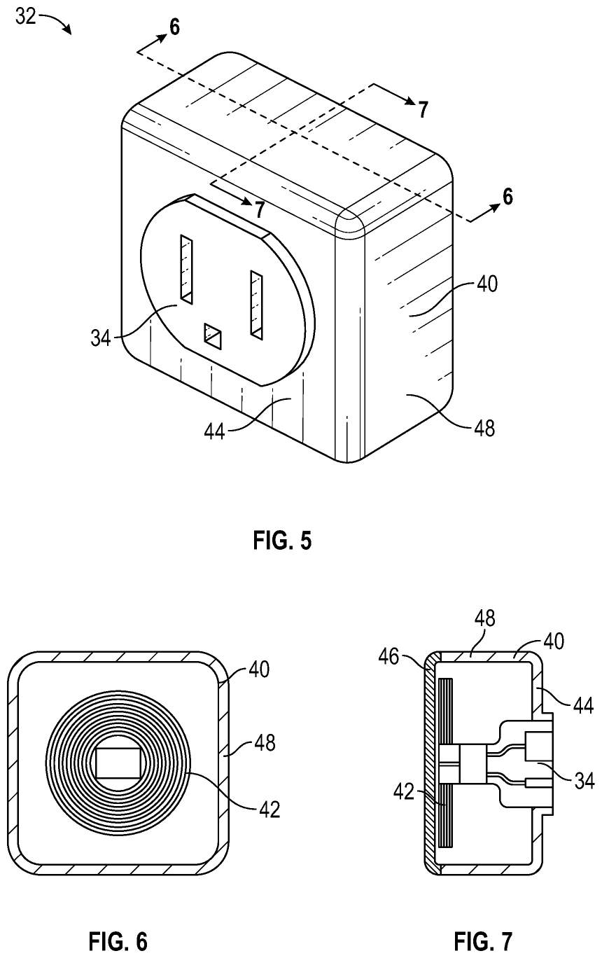

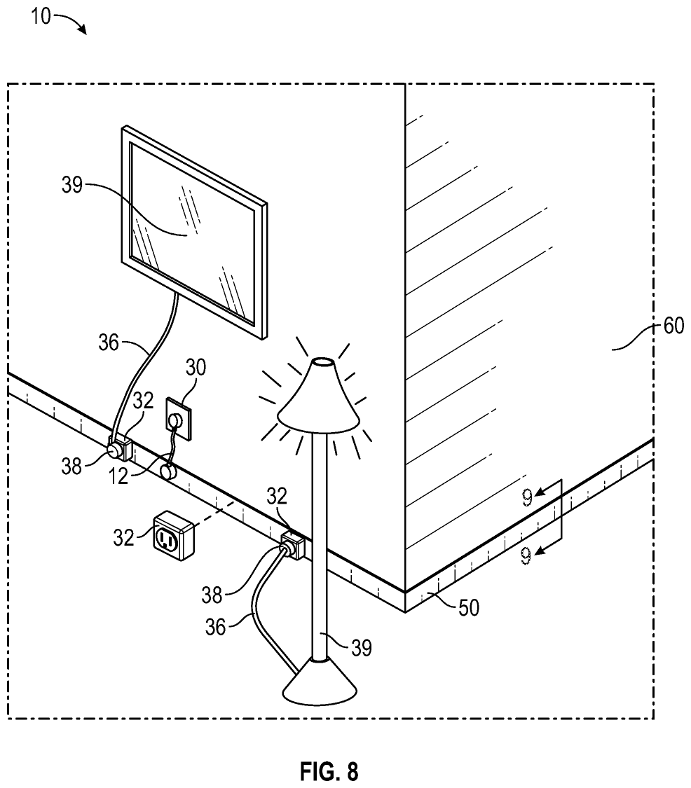

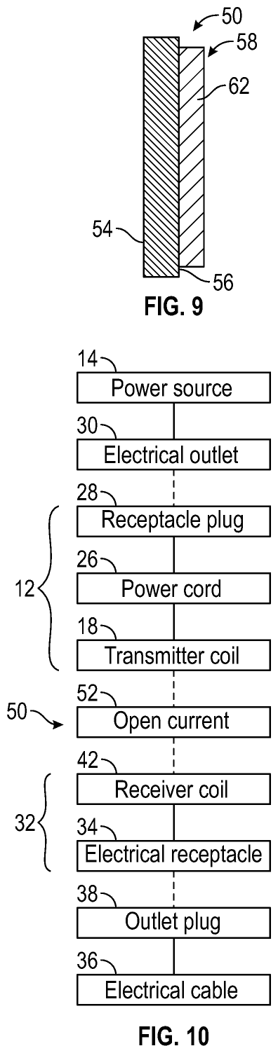

With reference now to the drawings, and in particular to FIGS. 1 through 10 thereof, a new electrical receptacle embodying the principles and concepts of an embodiment of the disclosure and generally designated by the reference numeral 10 will be described.

As best illustrated in FIGS. 1 through 10, the magnetized power transfer assembly 10 generally comprises an electricity transmitter 12 configured for transmitting electricity from a power source 14. The electricity transmitter 12 comprises a housing 16 enclosing a transmitter coil 18, wherein the transmitter coil 18 is configured for transmitting electricity. The housing 16 has a first wall 20, a second wall 22, and a perimeter wall 24. The housing 16 has a cylindrical configuration such that the first wall 20 and the second wall 22 are circular and a cross-sectional view of the perimeter wall 24 is circular as shown in FIG. 3. The transmitter coil 18 is positioned adjacent to the second wall 22 within the housing 16 and the second wall 22 is magnetic. A power cord 26 is electrically coupled to the transmitter coil 18 and extends outwardly from the housing 16. The power cord 26 has a receptacle plug 28 configured for inserting into an electrical outlet 30 of the power source 14.

An electricity receiver 32 is configured for receiving electricity from the electricity transmitter 12. The electricity receiver 32 has an electrical receptacle 34 thereon and is configured for receiving an outlet plug 38 of an electrical cable 36, wherein the electricity receiver 32 is configured to provide electricity from the electricity transmitter 12 to the electrical cable 36. The electrical cable 36 may be electrically coupled to a personal electronic device 39 such as a television or a lamp. Alternatively, the electricity receiver 32 may have a universal serial bus port thereon and be configured for receiving a universal serial bus plug. The electricity receiver 32 comprises a casing 40 enclosing a receiver coil 42, wherein the receiver coil 42 is configured for receiving electricity. The casing 40 has a front wall 44, a back wall 46, and a boundary wall 48. The casing 40 has a cubic configuration such that the front wall 44 and the back wall 46 are square shaped and a cross-sectional view of the boundary wall 48 is square shaped as shown in FIG. 6. The receiver coil 42 is positioned adjacent to the back wall 46 within the casing 40, and the back wall 46 is magnetic. The electrical receptacle 34 is positioned on the front wall 44 and is electrically coupled to the receiver coil 42.

A conductor strip 50 is couplable to the electricity transmitter 12 and to the electricity receiver 32. The conductor strip 50 is configured for transferring electricity from the electricity transmitter 12 to the electricity receiver 32 through an open current 52 within the conductor when the electricity transmitter 12 and the electricity receiver 32 are electrically coupled thereto. The conductor strip 50 includes a front surface 54 and a back surface 56. The front surface 54 is magnetic, wherein the front surface 54 is magnetically engageable with the back wall 46 of the electricity receiver 32 and with the second wall 22 of the electricity transmitter 12. The front surface 54 may comprise a ferrous material being conductive and magnetic. A mount 58 is coupled to the conductor strip 50 and is configured for mounting the conductor strip 50 to a surface 60 such as a wall. The mount 58 comprises an adhesive layer 62 positioned on the back surface 56 of the conductor strip 50 and is a pressure sensitive adhesive. Alternatively, the mount 58 may comprise a mounting bracket being configured for suspending from a hanging member such as nails attached to the wall.

In use, the mount 58 of the conductor strip 50 is attached to the surface 60. The receptacle plug 28 of the electricity transmitter 12 is engaged with the electrical outlet 30 of the power source 14 and the second wall 22 of the electricity transmitter 12 is magnetically engaged with the front surface 54 of the conductor strip 50, wherein the electricity transmitter 12 coil transmits electricity to the open current 52 of the conductor strip 50. The back wall 46 of the electricity receiver 32 is magnetically engaged with the front surface 54 of the conductor strip 50, wherein the receiver coil 42 receives electricity from the open current 52 of the conductor strip 50. The electrical receptacle 34 of the electricity receiver 32 may receive the outlet plug 38 of the electrical cable 36, wherein the electricity receiver 32 provides electricity to the electrical cable 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A magnetized power source assembly comprising:
an electricity transmitter being configured for transmitting electricity from a power source;
an electricity receiver being configured for receiving electricity from said electricity transmitter, said electricity receiver having an electrical receptacle thereon and being configured for receiving an outlet plug of an electrical cable, wherein said electricity receiver is configured to provide electricity from said electricity transmitter to the electrical cable;
a conductor strip being couplable to said electricity transmitter and to said electricity receiver, said conductor strip being configured for transferring electricity from said electricity transmitter to said electricity receiver through an open current within said conductor when said electricity transmitter and said electricity receiver are electrically coupled thereto; and
a mount being coupled to said conductor strip and being configured for mounting said conductor strip to a surface.

2. The magnetized power source assembly of claim 1, wherein said electricity transmitter comprises a housing enclosing a transmitter coil, wherein said transmitter coil is configured for transmitting electricity, said housing having a first wall, a second wall, and a perimeter wall, said transmitter coil being positioned adjacent to said second wall within said housing, said second wall being magnetic a power cord being electrically coupled to said transmitter coil and extending outwardly from said housing, said power cord having a receptacle plug configured for inserting into an electrical receptacle.

3. The magnetized power source assembly of claim 2, wherein said electricity receiver comprises a casing enclosing a receiver coil, wherein said receiver coil is configured for receiving electricity, said casing having a front wall, a back wall, and a boundary wall, said receiver coil being positioned adjacent to said back wall within said casing, said back wall being magnetic, said electrical receptacle being positioned on said front wall, said electrical receptacle being electrically coupled to said receiver coil.

4. The magnetized power source assembly of claim 3, wherein said conductor strip includes a front surface and a back surface, said front surface being magnetic, wherein said front surface is magnetically engageable with said back wall of said electricity receiver and with said second wall of said electricity transmitter.

5. The magnetized power source assembly of claim 4, wherein said mount comprises an adhesive layer positioned on said back surface of said conductor strip, said adhesive layer being a pressure sensitive adhesive.

6. A magnetized power source assembly comprising:
an electricity transmitter being configured for transmitting electricity from a power source, said electricity transmitter comprising a housing enclosing a transmitter coil, wherein said transmitter coil is configured for transmitting electricity, said housing having a first wall, a second wall, and a perimeter wall, said transmitter coil being positioned adjacent to said second wall within said housing, said second wall being magnetic, a power cord being electrically coupled to said transmitter coil and extending outwardly from said housing, said power cord having a receptacle plug configured for inserting into an electrical receptacle;
an electricity receiver being configured for receiving electricity from said electricity transmitter, said electricity receiver having an electrical receptacle thereon and being configured for receiving an outlet plug of an electrical cable, wherein said electricity receiver is configured to provide electricity from said electricity transmitter to the electrical cable, said electricity receiver comprising a casing enclosing a receiver coil, wherein said receiver coil is configured for receiving electricity, said casing having a front wall, a back wall, and a boundary wall, said receiver coil being positioned adjacent to said back wall within said casing, said back wall being magnetic, said electrical receptacle being positioned on said front wall, said electrical receptacle being electrically coupled to said receiver coil;
a conductor strip being couplable to said electricity transmitter and to said electricity receiver, said conductor strip being configured for transferring electricity from said electricity transmitter to said electricity receiver through an open current within said conductor when said electricity transmitter and said electricity receiver are electrically coupled thereto, said conductor strip including a front surface and a back surface, said front surface being magnetic, wherein said front surface is magnetically engageable with said back wall of said electricity receiver and with said second wall of said electricity transmitter; and
a mount being coupled to said conductor strip and being configured for mounting said conductor strip to a surface, said mount comprising an adhesive layer positioned on said back surface of said conductor strip, said adhesive layer being a pressure sensitive adhesive.
